(19) United States
(12) Patent Application Publication
(10) Pub. No.: US 2025/0219108 A1
(43) Pub. Date: Jul. 3, 2025

(54) FUEL CELL COMPONENTS INCLUDING GRAPHYNE

(71) Applicant: Robert Bosch GmbH, Stuttgart (DE)

(72) Inventors: Sergei CHUMAKOV, Palo Alto, CA (US); Daniil KITCHAEV, Brookline, MA (US)

(21) Appl. No.: 18/401,024

(22) Filed: Dec. 29, 2023

(51) Int. Cl. H01M 8/0228; H01M 8/021; H01M 8/0213

(52) U.S. Cl. CPC H01M 8/0228; H01M 8/021; H01M 8/0213

(57) ABSTRACT

A fuel cell bipolar plate includes a substrate, and one or more protective layers. The one or more protective layers are adjacent to the substrate, wherein the one or more protective layers contain a number of graphyne molecules, such that each graphyne-containing layer is configured to lower hydrogen adsorption into the substrate when compared to a substrate region free from the protective layers.

The following applications are related to the present application: U.S. patent application Ser. No. ______ (RBPA0475PUS), U.S. patent application Ser. No. ______ (RBPA0477PRV), and U.S. patent application Ser. No. ______ (RBPA0478PUS), and U.S. patent application Ser. No. ______ (RBPA0479PUS), which are each incorporated by reference in their entirely herein.

### TECHNICAL FIELD

The present disclosure relates to fuel cell components including graphyne. The fuel cell component may be a bipolar plate that includes graphyne. The fuel cell component may also be a catalyst material mixed with graphyne or a catalyst support including graphyne.

### BACKGROUND

Metals have been a widely used material for thousands of years. Various methods have been developed to preserve metals and prevent their corrosion or disintegration into oxides, hydroxides, sulfates, and other salts. Metals in some industrial applications are especially susceptible to corrosion due to aggressive operating environments. A non-limiting example may be metal components of a fuel cell (e.g. bipolar plates). For instance, bipolar plates are required to be not only sufficiency chemically inert to resist degradation in a highly corrosive environment of the fuel cell, but also electrically conducting to facilitate electron transfer for the oxygen reduction reaction of the fuel cell.

### SUMMARY

In one embodiment, a fuel cell bipolar plate includes a substrate, and one or more protective layers. The one or more protective layers are adjacent to the substrate, wherein the one or more protective layers contain a number of graphyne molecules, such that each graphyne-containing layer is configured to lower hydrogen adsorption into the substrate when compared to a substrate region free from the protective layers.

In another embodiment, a fuel cell bipolar plate includes a substrate having first and second surfaces; and one of more protective layers. The one or more protective layers are adjacent to at least one of the first and/or second surfaces, wherein the one or more protective layers contain a number of gamma-graphyne molecules, such that the one or more protective layers are configured to lower hydrogen adsorption into the substrate when compared to a substrate region free from the protective layers.

In yet another embodiment, a fuel cell bipolar plate includes a body including a bulk region; and one of more protective layers. The one or more protective layers are adjacent to the bulk region, wherein the one or more protective layers contain a graphdiyne material, such that the one or more protective layers are configured to lower hydrogen adsorption into the bulk region when compared to a bulk region free from the protective layers.

### BRIEF DESCRIPTION OF THE DRAWINGS

FIG. 1 is a schematic, cross-sectional view of a fuel cell.

FIG. 2 is a schematic, perspective view of components of the fuel cell shown in FIG. 1.

FIG. 3 is a schematic, side view of a fuel cell stack including a plurality of the individual fuel cells as shown in FIGS. 1 and 2.

FIG. 4 is a schematic, cross section view of a bipolar plate of the fuel cell shown in FIGS. 1 and 2.

FIGS. 5A through 5E present examples of graphyne-based materials: α-graphyne (FIG. 5A), β-graphyne (FIG. 5B), γ-graphyne (FIG. 5C), graphdiyne (FIG. 5D) and 6,6,12-graphyne (FIG. 5E).

FIG. 6A is a 2D chemical structure illustration of a part of a single molecule of gamma-graphyne.

FIG. 6B is a 2D chemical structure illustration of three layers of gamma-graphyne stacked in ABC-stacking.

FIG. 7A is a graphical representation of energy with respect to reaction coordinates illustrating the energy required to hold a molecule of hydrogen gas at various locations along the line perpendicular to the plane of ABC-stacked gamma-graphyne.

FIG. 7B is a 2D chemical structure illustration of three layers of gamma-graphyne stacked in ABC-stacking illustrating a location a hydrogen molecule may passes through one of the benzene rings.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word about in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for given purpose in connection with the invention implies the mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This invention is not limited to the specific embodiments and methods described below, as specific components and/or conditions may vary. Furthermore, the terminology used herein is used only for the purpose of describing particular embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1 to 10 explicitly includes 1, 2, 3, 4, 5, 6, 7, 8, 9 and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

Corrosion may cause degradation in fuel cell metal components, such as bipolar plates. Corrosion is a process by which refined metal is converted to a more chemically stable form such as a metal oxide, hydroxide, sulfide and/or other salts. The more chemically stable form may be less desirable because it exhibits one or more less desirable properties or inhibits one or more desirable properties. The conversion may present a steady destruction of the metal material. The conversion may include the electrochemical oxidation of the metal with an oxidant such as oxygen or water. Corrosion may occur when a metal component is exposed to moisture in the air, to a solution with a relatively low pH or high pH, and/or various chemical substances such as acids and/or microbes. Elevated temperatures may also accelerate corrosion. What is needed are nitride materials for use in fuel cell metal components, such as bipolar plates, catalyst supports and catalyst materials, that have corrosion resistant characteristics. What is further needed are protective nitride materials capable of imparting anti-corrosive properties onto metal substrate in other chemically aggressive environments.

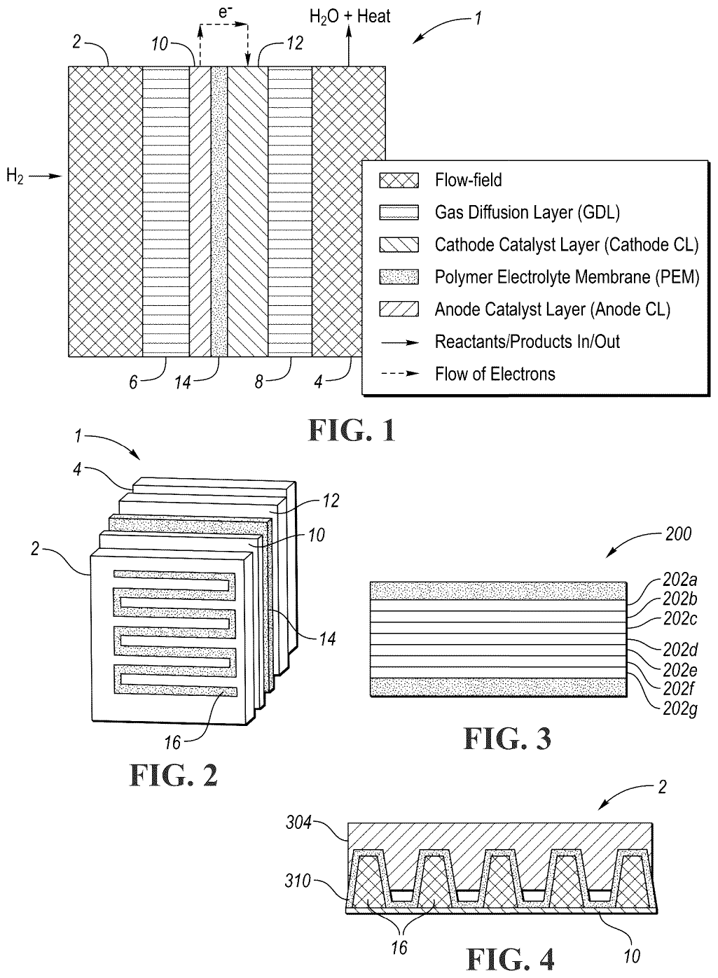

FIG. 1 is a schematic, cross-sectional view of fuel cell 1. FIG. 2 is a schematic, perspective view of components of fuel cell I shown in FIG. 1. FIG. 1 also generally depicts the reactants and products of the operation of fuel cell 1. As shown in FIG. 1, first and second bipolar plates 2 and 4 are positioned at opposite ends of fuel cell 1 and surround first and second gas diffusion layers (GDLs) 6 and 8. The bipolar plates 2 and 4 are typically formed of a metal material. First and second bipolar plates 2 and 4 may include flow-field plates.

Bipolar plates 2 and 4 may provide structural support, conductivity, and may assist in supplying fuel and oxidants (air). Bipolar plates 2 and 4 may also assist in removal of reaction products or byproducts. Bipolar plate 2 includes flow passage 16 and bipolar plate 4 also includes a flow passage (not shown). The flow passages are configured to assist in supplying fuel and/or removing by-products. In one or more embodiments, the depth of a flow passage may be about 0.5 mm. In one or more embodiments, the width of a flow passage may be about 1 mm. In one or more embodiments, a flow passage may be greater than about 1 mm. Bipolar plates 2 and 4 may help regulate or manage thermal conditions in fuel cell 1. Bipolar plates 2 and 4 may contribute significantly to the weight and cost of fuel cell. Bipolar plates 2 and 4 may be made of metal, graphite, composite and/or polymer material. A metal bipolar plate may be made from stainless steel, a titanium-based metallic material or a combination thereof. Bipolar plates 2 and 4 may include a coating. For instance, the bipolar plates 2 and 4 may include graphyne or a coating of graphyne as disclosed in one or more embodiments herein.

First and second catalyst layers 10 and 12 are positioned between first and second gas diffusion layers GDLs 6 and 8 and may be separated by a polymer electrolyte membrane (PEM) 14. As shown in FIG. 1, first catalyst layer 10 is an anode catalyst layer and second catalyst layer 12 is a cathode catalyst layer. Catalyst layers 10 and/or 12 may be supported by a catalyst support material. The catalyst support material may be formed of a metal material. Catalyst layers 10 and 12 include a catalyst material formed of a metal material such as Pt. As shown in FIG. 1, The hydrogen and oxygen reactants are introduced into fuel cell 10 through an opposing flow field and current flows from first catalyst layer 10 (anode catalyst layer) to second catalyst layer 12 (cathode catalyst layer) resulting in the production of H₂O and heat.

In one or more embodiments, fuel cell 1 may be a proton exchange membrane fuel cell (PEMFC). A PEMFC includes a proton exchange membrane, which may also be referred to as a polymer electrolyte membrane (PEM). A membrane electrode assembly (MEA) refers to the membrane, electrodes and may refer to a catalyst or catalyst layer. The catalyst layers may include carbon paper or a carbon support. In one or more embodiments, the MEA may include a gas diffusion layer. PEMFCs commonly operate in acidic environments and may have increased operating temperatures. For example, a PEMFC may operate between about −20 and 100° C.

A core component of a PEMFC is the MEA, which assists the electrochemical reaction within the stack. The MEA includes a PEM through which protons are transferred. As noted above, PEMs commonly comprise polymer-based electrolyte materials such as Nafion. In addition to a PEM, the MEA may also include other subcomponents such as electrodes and catalysts as already described in connection with FIG. 1. Within the MEA, protons are transferred from an anode to a cathode through a PEM and its associated polymer electrolyte. The electrodes may be made of any suitable material and may be heat pressed onto the PEM within the MEA. The anode and cathode electrodes also commonly contain a catalyst layer comprising Pt or another Pt-group metal such as ruthenium. In addition to the MEA and its various subcomponents, a PEMFC also typically includes other components such as current collectors, GDLs, gaskets, and at least one bipolar plate (BPP).

Bipolar plates 2 and 4 may connect and divide individual fuel cells to form a fuel cell stack. Fuel cells may be stacked to increase voltage and/or power. FIG. 3 is a schematic, side view of fuel cell stack 200 including a plurality of the individual fuel cells shown in FIGS. 1 and 2. Fuel cell stack 200 includes a plurality of fuel cells 202a through 202g. FIG. 4 is a schematic, cross-section view of bipolar plate 2 of fuel cell 1. Bipolar plate 2 includes substrate 304 and surface layer coating 310.

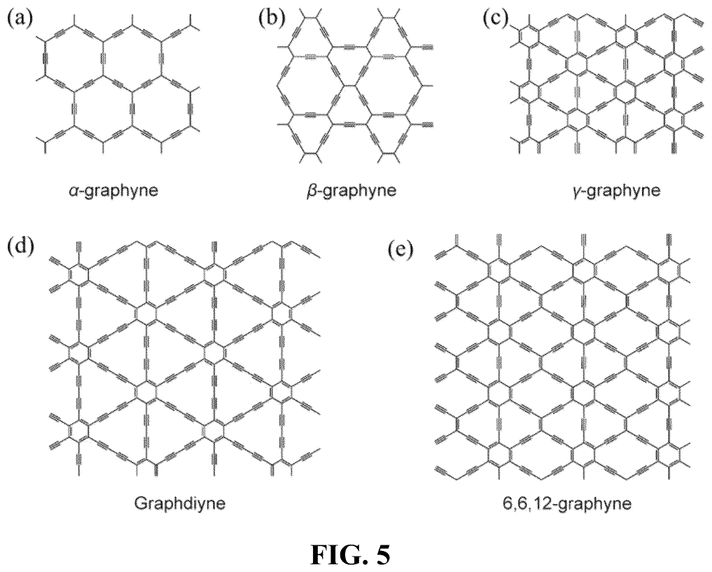

There are various hybridization states (sp, sp², sp³) of carbon that allow diverse covalent bonding between carbon atoms and result in numerous carbon allotropes. For example, the two most stable natural carbon allotropes are graphite and diamond, which have sp² and sp³ hybridization characters, respectively. Graphynes are a family of carbon allotropes that have one-atom-thickness and sp and sp² carbon atoms. Graphynes can be constructed by either partially or completely replacing the C—C bonds in graphene with one or more acetylenic groups —C≡C—. Schematic of a molecular structure of several graphynes are shown in the FIG. 5.

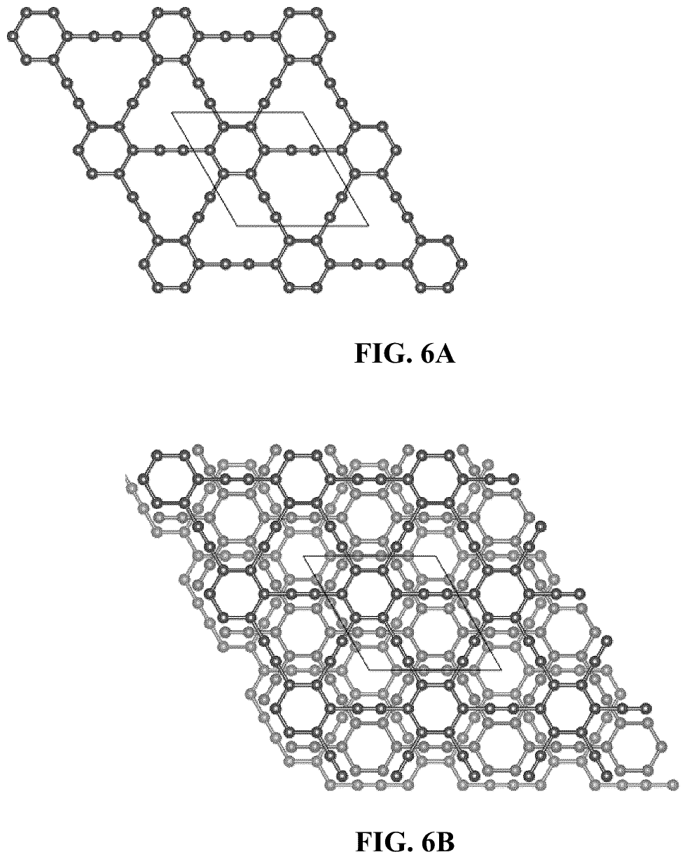

FIGS. 5A through 5E present examples of graphyne-based materials: α-graphyne (FIG. 5A), β-graphyne (FIG. 5B), γ-graphyne (FIG. 5C), graphdiyne (FIG. 5D) and 6,6,12-graphyne (FIG. 5E). In one or more embodiments, graphdiyne may be manufactured using a bulk synthesis method (e.g., copper foil method, diatomite substrate, explosion method, and/or controlled release method) or a thin film synthesis (e.g., about nanometer thickness). Non-limiting examples of thin film analysis include interface between liquids, Si substrate, microwave-induced method, and peeling in aqueous solution of Li₂SiF₆.

In one or more embodiments, the graphyne-based material exists in a stable form of a single infinitely large 2D molecule. These graphynes may be used in coatings to resist hydrogen gas leakage from bipolar plates. FIG. 6A depicts a single-layer molecule of gamma-graphyne. The gamma-graphyne may tend to form flakes that have thickness of several layers (e.g., three layers of graphyne molecules). In one or more embodiments, the preferred stacking of these three layers is called “ABC-stacking” and is shown in the FIG. 6B.

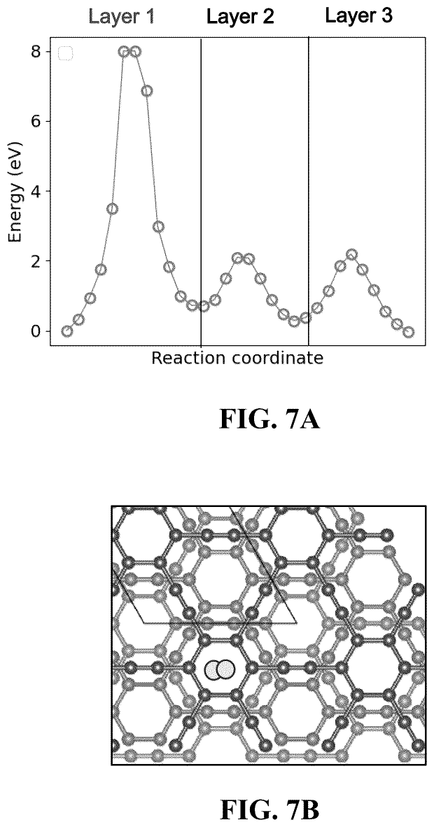

The ability of gamma-graphyne to resist (e.g., prevent) hydrogen molecules from passing through have been verified computationally by using a computer program that employs Density Function Theory (DFT). FIG. 7A shows results of DFT-based calculations which show energy levels that are required to keep a molecule of hydrogen in a sequence of positions along the line that is perpendicular to the ABC-stacked graphyne and passes through one of benzene rings. FIG. 7B shows the view of ABC-stacked graphyne layer with a hydrogen molecule. From the calculations it is evident that the minimum energy required for the hydrogen molecule to pass through a large hole in a single layer of gamma-graphyne equals to 2 eV. This shows that a single-molecule layer of gamma-graphyne is impenetrable to hydrogen under projected conditions. Under the scenario that gamma-graphyne forms a three-layer configuration with ABC-stacking, the hydrogen molecule would have to pass through one of benzene rings to cross all three graphyne layers. Thus, the minimum energy of hydrogen molecule required to cross all three layers of gamma-graphyne is close to 8 eV, which is unachievable under projected conditions. In one or more embodiments, projected conditions are pressure of 700 bar, temperature less than 200 C, and concentration of hydrogen is 100%.

In one or more embodiments, a bipolar plate with one or more graphyne-containing layers is disclosed. The bipolar plate may have similar dimensions, configuration, parts, and shape as bipolar plate 1 depicted in FIG. 1 and FIG. 2. The bipolar plate may be configured to channel pressurized hydrogen gas.

The bipolar plates 2 and 4 may include one or more graphyne-containing layers 310, among other layers, adjacent to the bulk material region 304 as is depicted in FIGS. 4. The graphyne-containing layer(s) 310 may include one or more graphyne molecules having such morphology that the graphyne-containing layer(s) 310 are configured to minimize and suppress hydrogen binding, adsorption, and/or dissociation reactions, slow down corrosion of the bipolar plate, or a combination thereof.

One or more embodiments disclose one or more graphyne-based (e.g., graphyne or doped graphyne) coating layers and their fabrication and integration upon the surface of bipolar plate. In one embodiment, the graphyne-based coating includes layers of graphyne-based material. The graphyne-based material may be a graphyne material, a doped graphyne or graphyne oxide material, or a combination thereof. For instance, the graphyne-based material may be a graphdiyne material subjected to heteroatom doping (e.g., Ca, N, S, F, and/or Cl). As another example, the graphyne-based material may be a graphdiyne material doped with one or more transitional metals (e.g., Cu, Pd, Ni, and/or Fe).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A fuel cell bipolar plate comprising:
a substrate; and
one or more protective layers adjacent to the substrate, wherein the one or more protective layers contain a number of graphyne molecules, such that each graphyne-containing layer is configured to lower hydrogen adsorption into the substrate when compared to a substrate region free from the protective layers.

2. The fuel cell bipolar plate of claim 1, wherein graphyne is gamma-graphyne.

3. The fuel cell bipolar plate of claim 2, wherein the gamma-graphyne is stacked in a ABC configuration.

4. The fuel cell bipolar plate of claim 1, wherein the one or more protective layers include a binder material.

5. The fuel cell bipolar plate of claim 1, wherein a total thickness of the one or more protective layers form a thin film of 0.6 nanometers to 5 millimeters.

6. The fuel cell bipolar plate of claim 1, wherein the one or more protective layers is a single protective layer.

7. The fuel cell bipolar plate of claim 1, wherein the substrate is formed from stainless steel, a titanium-based metallic compounds, a composite, or a combination thereof.

8. The fuel cell bipolar plate of claim 1, wherein the one or more protective layers is limited to a flow passage.

9. A fuel cell bipolar plate comprising:
a substrate having first and second surfaces; and
one or more protective layers adjacent to at least one of the first and/or second surfaces, wherein the one or more protective layers contain a number of gamma-graphyne molecules, such that the one or more protective layers are configured to lower hydrogen adsorption into the substrate when compared to a substrate region free from the protective layers.

10. The fuel cell bipolar plate of claim 9, wherein the substrate is formed from stainless steel, a titanium-based metallic compounds or a combination thereof.

11. The fuel cell bipolar plate of claim 9, wherein the one or more protective layers comprised of a plurality of layers.

12. The fuel cell bipolar plate of claim 11, wherein each of the plurality of layers has a thickness of 0.6 nanometers to 1 millimeter.

13. The fuel cell bipolar plate of claim 8, wherein the gamma-graphyne is stacked in a ABC configuration.

14. The fuel cell bipolar plate of claim 13, wherein the graphyne molecules are flakes of graphyne.

15. The fuel cell bipolar plate of claim 14, wherein the flakes of graphene are overlapping.

16. A fuel cell bipolar plate comprising:
a body including a bulk region; and
one or more protective layers adjacent to the bulk region, wherein the one or more protective layers contain a graphdiyne material, such that the one or more protective layers are configured to lower hydrogen adsorption into the bulk region when compared to a bulk region free from the protective layers.

17. The fuel cell bipolar plate of claim 16, wherein the graphdiyne material includes a calcium-doped graphdiyne material.

18. The fuel cell bipolar plate of claim 16, wherein the graphdiyne material includes a heteroatom-doped graphdiyne material.

19. The fuel cell bipolar plate of claim 16, wherein the heteroatom-doped graphdiyne material is doped with N, S, F, and/or Cl.

20. The fuel cell bipolar plate of claim 16, wherein a total thickness of the one or more protective layers form a thin film of 0.6 nanometers to 1 millimeter.
